(19) United States
(12) Patent Application Publication
(10) Pub. No.: US 2012/0072430 A1
(43) Pub. Date: Mar. 22, 2012

(54) System for Managing Moveable Assets Using Automatic Identification and Data Capture Technology, and Method for Operating Same

(76) Inventor: Whon-Il Park, Seocho-ku (KR)

(21) Appl. No.: 13/139,512

(22) PCT Filed: Jun. 4, 2009
(86) PCT No.: PCT/KR2009/002973

§ 371 Date: Nov. 29, 2011

(30) Foreign Application Priority Data
Dec. 12, 2008 (KR) 10-2008-0126325

(51) Int. Cl. G06F 17/30

(52) U.S. Cl. 707/748; 707/825; 707/E17.009

(57) ABSTRACT

A Movable Asset Management System using Automatic Identification and Data Capture (AIDC) Devices and a method for operating the same are disclosed. The movable asset management system using AIDC technologies includes: AIDC devices storing information about movable property and/or movable property collateral and transmitting the same to an external device; information posted on the movable property and used to specify such movable property; location information of the movable property; and/or information identifying a owner of the movable property, and information about the movable property including current status of usage and/or information identifying an obligor and a secured creditor, when security interest is created thereon; information on the secured credit amount and maximum amount of the security interest, if necessary; and/or information about the movable property collateral including, but not limited to, the cause of registration, date, existence period and a serial number of registration, when the security interest has been registered; a mobile reader receiving the information about the movable property and/or the movable property collateral, transmitted from the AIDC devices, and transmitting the information about the movable property and/or the movable property collateral to a database system via networks. The database system includes: a communication unit receiving the information about the movable property and/or the movable property collateral from the mobile reader; a database storing the information about the movable property and/or the movable property collateral; a control unit storing the information about the movable property and/or the movable property collateral, received from the mobile reader, in the database and managing the database; a display unit connected to the control unit and displaying the information about the movable property and/or the movable property collateral, received by the communication unit; and an input unit connected to the control unit, which is operated by a user to retrieve and search the information about the movable property and/or the movable property collateral, stored in the database. This system of the present invention manages an individual movable property or collective movable properties with AIDC devices attached thereto (or embedded therein) and to provide the systematic asset/facility management services by utilizing the database in an efficient manner by means of computers and the Internet.

### TECHNICAL FIELD

The present invention relates to a movable asset management system using Automatic Identification and Data Capture (hereinafter referred to as “AIDC”) Devices and a method for operating the same, and more particularly to a movable asset management system for generating information about movable properties and/or movable property collateral, obtained from AIDC Devices attached to or embedded in movable properties into a database when a security interest is created thereon, and for managing movable assets based on the database, and a method for operating the same.

### BACKGROUND

The present invention is the extension of the following related patent 1 which discloses the publicity system using Radio Frequency Identification (hereinafter referred to as “RFID”) tags for the management of collateral with the non-possessory security interest thereon.
Related patent 1: Korean Patent No. 10-0620399.

The related patent 1 discloses a non-possessory collateral publicity system using RFID technologies for the management of movable property as collateral. The related patent 1 discloses the RFID tags attached to movable properties such as machinery and equipment, inventory, etc. as collateral, an RFID reader/writer, and a non-possessory security interest publicity system using the same.

The RFID tag includes: a storage unit recording non-possessory security interest information including a specific information area specifying a movable property, information containing filing date and a registration number, and an information area on an obligor (owner) of the movable property, an information area on secured creditors, an information area on the purpose and cause of security registration, an information area on the secured credits, and an information area on the term of existence of the security registration, respectively; and an RF transmitter/receiver reading out the information recorded in the storage unit and transmitting the same outward in accordance with RF signals.

The related invention 1 provides the security interest publicity system based on RFID technologies when the security interest is created on the movable property, and manages the movable property collateral in an efficient manner.

However, the related patent 1 has the following shortcomings:

First, there is no function of dealing with the systematic collateral management by building a database on the movable property as collateral.

Second, there is no function of comparing data stored in the database with those stored in a movable property electronic registration server, to check whether double registration is made on a single movable property.

Third, there is no function of alarming when a movable property is moved out of an initial location and of searching for current status and history of the movable property for periodic comparison of the current status of the movable property with the history.

Fourth, there is no function of rating the movable property after the periodic comparison of the current status of the movable property with the history, and thus of evaluating the movable property based on the rating.

Fifth, there is no function of disclosing information necessary for the trading of the movable property and of providing advice to search for a would-be buyer for the prompt disposal of the movable property.

### DISCLOSURE

### Technical Problem

The invention has been made in view of the problems, and it is an aspect of the present invention to provide a movable asset management system by attaching AIDC devices with RFID tags to a movable property and using AIDC technologies based on information stored in the AIDC devices for the efficient management of the movable property, and a method of operating the same.

First, the present invention also provides a database system for systematically managing movable properties. Second, the present invention provides a movable property electronic registration system for comparing and reconciling information stored in a database with that stored in the movable property electronic registration server, to detect whether there is double registration of a single movable property.

Third, the present invention also provides a movable property security system for alarming when a movable property is moved out of a preset location, and for comparing the status quo movable property with history thereof periodically.

Fourth, the present invention also provides a movable property evaluation system for rating the movable property after the periodic comparison of the current status of the movable property with the history, and for evaluating the movable property based on the rating.

Fifth, the present invention further provides a movable property disposal system for disclosing information for the trading of a movable property and for providing advice to search for a would-be buyer for the disposal of the movable property.

The present invention provides services of systematically managing asset/facility by utilizing a database efficiently with computers and the Internet for the management of an individual movable property and/or collective movable properties with AIDC devices attached thereto.

### Technical Solution

In order to attain the said purpose, the movable asset management system using AIDC technologies has been provided and is characterized by:

the AIDC devices which store and transmit outward the below-mentioned information regarding the movable property and/or movable property collateral:
the information posted on the movable property and used to specify such movable property;
the location information of the movable property; and/or
the information identifying the owner(s) of the movable property, and the information about the movable property including its current status of usage and/or the information identifying the obligor and the secured creditor, if the security interest is created thereon;
the information on the secured credit amount and its maximum amount of the said security interest, if any; and/or
the information on the movable property collateral including, but not limited to, the cause of registration, the date, existence period and the filing number of registration, if the said security interest has been registered;
   the mobile reader which receives the information regarding such movable property and/or movable property collateral, transmitted from the said AIDC devices, and transmit the information regarding such movable property and/or movable property collateral to the database system via networks; and
   the said database system comprising:
the communication unit which receives the information regarding such movable property and/or movable property collateral from the said mobile reader;
the database which stores the information regarding such movable property and/or movable property collateral;
the control unit which stores in the database the information regarding such movable property and/or movable property collateral, received from the said mobile reader, and manages the said database;
the display unit, connected to the said control unit, which shows on the monitor the information regarding such movable property and/or movable property collateral, received by the said communication unit; and
the input unit, connected to the said control unit, which is operated by the user to retrieve and search the information regarding such movable property and/or movable property collateral, stored in the said database.

Desirably, the movable asset management system using AIDC technologies has been provided and characterized by the movable property electronic registration in addition, which makes it possible to compare and reconcile the information regarding such movable property and/or movable property collateral transmitted from the said control unit and then stored upon receiving, with the original information regarding such movable property and/or movable property collateral stored in the said database so as to detect any double registration of the same movable property.

Desirably, the gate reader which is checking if any movable property is moved out of the location of such movable property recognized by the information regarding such movable property stored in the said database; and

the movable asset management system using AIDC technologies has been provided and characterized by the movable property security system in addition, which gives a warning signal when such movable property is moved out of the said location subject to the check conducted by the said gate reader, and makes a display of the result of the periodic comparison and analysis of the status quo movable property with its traceable history.

Desirably, the movable asset management system using AIDC technologies has been provided and characterized by the movable property evaluation system in addition, which generates an appropriate score or rate subject to the periodic comparison and analysis of the status quo movable property with its traceable history, and assesses the value of such movable property based on the said score or rate.

Desirably, the movable asset management system using AIDC technologies has been provided and characterized by the movable property disposal system in addition, which makes proper categorization and combination of the information regarding such movable property and/or movable property collateral under certain criteria based on the said database, and discloses any information necessary for the trading of such movable property.

### Advantageous Effects

As described above, the present invention provides the movable asset management system using AIDC technologies based on information stored in the AIDC devices for the efficient management of the movable property and the method of operating the same.

Also, the invention provides the database system, the movable property electronic registration system, the movable property security system, the movable property evaluation system, and the movable property disposal system so that individual and/or collective movable properties with AIDC devices attached thereto may be effectively managed using the database through computers and Internet and that the systematic asset/facility management services may be also provided.

Further, the present invention is advantageous to yield the highest efficiency in managing the movable property collateral, for which the existing methods hardly achieve in view of time and costs. It is expected that the prevailing banking practices are gradually changed from heavy dependence on real estate rather than movable properties when the invention is applied in the field of the art. In addition, when the present invention will be serviced by professional security service agents, creditor banks may outsource the professional services as provided by the present invention with moderate expenses, and actively take high valued movable properties possessed by small and medium-sized enterprises, which could take advantage of bank loans by granting the properties as collateral on good terms.

As to the economies, which prefer movable properties as collateral, like Japan, China, Vietnam, Indonesia, Thailand, Mongolia, Uzbekistan, Kazakhstan, etc., the export of professional movable property collateral management services and related information technologies as well as the movable asset management system using AIDC technologies according to the present invention and the method of operating the same may be expected in the future.

### MODE FOR INVENTION

Hereinafter, exemplary embodiments of the present invention will be described in detail with reference to accompanying drawings. The same reference symbols are used throughout the drawings to refer to the same or like parts.

FIG. 1 shows a movable asset management system 1 using AIDC technologies in accordance with an embodiment of the present invention.

The movable asset management system 1 using AIDC technologies in accordance with the embodiment of the present invention includes AIDC devices 20 attached to or embedded in movable properties 10, mobile readers 30 and a database system 100.

The AIDC technologies, employed in the present invention, are catch-all concept including not only RFID tags and two-dimensional bar codes but also a state-of-the-art AIDC device in the near future. As to the high priced movable properties 10, RFID tags and even the sophisticated active RFID tags with GPS devices may be attached. Two-dimensional bar codes may be used to cost sensitive movable properties.

In the embodiment of the present invention, when the RFID tags are attached to an individual movable property 10, a RFID system including terminals with 500 Mhz, 900 Mhz, and 2.45 Ghz bandwidth, respectively, RFID readers, and RFID tags is employed in the movable asset management system using AIDC technologies according to the embodiment of the present invention. When two-dimensional bar codes are used, the AIDC system includes the terminals and the RFID readers.

The AIDC device 20 attached to movable properties 10 stores information of specifying the movable properties 10, location information thereof, information of identifying owner(s) thereof and current status of usage thereof, and transmits the information to an outer device.

Also, the AIDC device 20 stores information of identifying an obligor and a secured creditor when security interest is created thereon, information on the secured credit amount and the maximum amount of the security interest, information on the movable property collateral including cause of registration, date, existence period, and a filing number of registration when the security interest has been registered, and transmits the information to the outer device.

According to the movable asset management system of the embodiment, the AIDC device 20 transmits only the information on the movable property 10 when the security interest is not created. But the AIDC device 20 transmits the information on the movable property collateral as well when the security interest is created.

A mobile reader 30 receives the information on the movable property 10 and/or the movable property collateral, and transmit the received information to a communication unit 120 of a database system 100 via networks 40.

On the other hand, the database system 100 includes a control unit 110, the communication unit 120, a database 130, a display unit 140, and an input unit 150.

The communication unit 120 receives the information on the movable property 10 and/or the movable property collateral from the mobile reader 30, while the database 130 stores the information on the movable property and/or the movable property collateral. The control unit 110 stores the information on the movable property and/or the movable property collateral received from the mobile reader 30 into the database 130, and manages the database 130.

The display unit 140, connected to the control unit 110, displays the information on the movable property and/or the movable property collateral received from the communication unit 120 on the monitor. The input unit 150, connected to the control unit 110, is operated by the user to retrieve and search for the information on the movable property and/or the movable property collateral stored in the database 130.

FIG. 2 shows the movable asset management system 1 using AIDC technologies of FIG. 1 including a movable property electronic registration system 200.

FIG. 2 shows the movable asset management system 1 according to the embodiment of the present invention including the AIDC devices 20, the mobile readers 30, the database system 100, and a movable property electronic registration system 200.

The movable property electronic registration system 200 includes a movable property electronic registration server 210, which receives the information on the movable property and/or the movable property collateral stored in the database 130 of the database system 100 from the control unit 110, and then which stores the received information. The movable property electronic registration system 200 detects double registration of a single movable property 10 by comparing the information on the movable property and/or the movable property collateral pre-stored with each other in the movable property electronic registration server 210.

The movable property electronic registration server 210 may be either the server operated by an enterprise of the movable asset management system 1 in accordance with the present invention on behalf of the government agency such as the Financial Supervisory Commission, or the server directly operated by a government agency in charge of registration of the movable property 10.

The movable asset management system 1 further includes the movable property electronic registration system 200, so that the database 130 may be directly utilized by the server (i.e., electronic registry) operated by the government agency, when the movable property collateral regime is legislated.

In this case, the movable property electronic registration system 200 may compare data stored in the database 130 with data registered in electronic registry of the government agency so as to check whether there is double registration of a single movable property 10.

FIG. 3 shows a block diagram of a movable asset management system 1 using AIDC technologies of FIG. 2 further including a movable property security system 300.

FIG. 3 shows the movable asset management system 1 using AIDC technologies including the AIDC devices 20, the mobile readers 30, the database system 100, the movable property electronic registration system 200, and a movable property security system 300.

According to the embodiment of the present invention, the movable asset management system 1 further includes a gate reader 50 in addition to the mobile reader 30, wherein the gate reader 50 checks whether a movable property is moved out of a location as recognized by the information on the movable property 10 stored in the database 130, and transmits the same to the communication unit 120. Thus the movable property security system 300 alarms when the movable property 10 is moved out of the location.

In addition, the mobile reader 30 is checking if any movable property 10 or its part is moved out or lost on the spot, and transmit it to the communication unit 120. Thus the movable property security system 300 compares the current status of the movable property 10 with history thereof periodically.

FIG. 4 shows a block diagram of the movable asset management system 1 using AIDC technologies including a movable property evaluation system 400 and a movable property disposal system 500.

As illustrated in FIG. 4, the movable asset management system 1 includes the AIDC devices 20, mobile the readers 30, the database system 100, the movable property electronic registration system 200, the movable property security system 300, the movable property evaluation system 400, and the movable property disposal system 500.

The movable property evaluation system 400 generates a score or rate of the movable property 10 after the periodic comparison of the current status of the movable property 10 with the history thereof, and assesses the value of the movable property 10 for the collateral management and pricing, based on the score or the rate.

The movable property evaluation system 400 produces a report on the scoring from ten to zero or the rating from A [excellent], B [good], C [bad] to D [useless] based on the status quo movable property 10, and use the report for the evaluation as collateral management and pricing.

The movable property disposal system 500 system 500, for the purpose of sale, exchange or disposition of the movable property 10, makes proper categorization and combination of the information on the movable property and/or the movable property collateral under a preset criteria based on the database, and discloses information necessary for the trading of the movable property 10. The movable property disposal system 500, for the effective management and disposition of the movable property, also conducts various advisory services including repair of the movable property, exchange and replacement of parts, search for potential foreign or local buyers, price negotiations, maintenance guarantee, and so on.

The movable property disposal system 500 enables the arrangement for the sale and purchase of the movable property at on-line/off-line marketplaces based on the database 130, and helps to conduct consulting services for the effective management and disposition of the movable property 10.

As described above, the movable asset management system 1 of the present invention may be applied to facilitate the movable asset management. For instance, a casualty insurance company may have the insured properties specified by AIDC devices, and guarded and protected by a professional security service agent.

What is urgently necessary in the near future is for a creditor bank to secure its loans to the solar houses implemented in accordance with the “Green Home” project conducted by Korean Government. The creditor bank is obliged to obtain the solar house equipment including solar panels, inverters, batteries, etc. as collateral.

In this case, the movable asset management system 1 using AIDC technologies and the database system 100 will make a solution as devised by this invention, in which RFID tags or other AIDC devices are attached to each of the solar house equipment to specify the movable property, and to store in AIDC devices the information as specifications, status of usage, location, etc. of the movable property, thus setting up a valuable database 130.

When the movable property collateral regime is legislated by the government as anticipated, the security interest on the movable property may be created and filed with the movable property electronic registry, which makes it possible to compare the data stored in the database with the data filed in the electronic registry so as to detect any irregularity, thus taking advantage of the movable property electronic registration system 200 as devised by this invention.

When it is necessary for a creditor bank to carry out collateral administration and check whether complicatedly-composed collateral is lost, and to conduct the periodic comparison of the current status of the movable property collateral with history, and to give a rate or a score for the management status of the movable property collateral, it may take any necessary measures based on the movable property security system 300 and the movable property evaluation system 400 according to the present invention.

When it is necessary to enforce the security interest and to dispose and collect loans, the arrangement for the sale and purchase, or exchange of the movable property based on the database may be carried out by the movable property disposal system 500 according to the present invention.

As for a creditor bank, it would be almost impossible to procure manpower, costs and time necessary to administer tens of thousand pieces of collateral of geographically scattered solar houses. On the contrary, it will be possible to conduct more efficient collateral administration when the movable asset management system 1 using AIDC technologies and the method of operating the same or a professional security service agent is employed as suggested by the present invention. A new value-added service which has adopted sophisticated information technology is expected to give rise to more and more jobs for youngsters.

FIG. 5 is a flowchart illustrating a method of operating the movable asset management system using AIDC technologies according to an embodiment of the present invention.

In the embodiment of the present invention, the method of operating the movable property management system stores the information on the movable property and/or the movable property collateral (S10a and S10b) in the AIDC devices 20. The information on the movable property and/or the movable property collateral are transmitted to the outer device, and received (S11a and S11b) by the mobile reader 30 from the AIDC devices 20 via the networks 40 and finally to the database system 100, which stores and manages (S12a and S12b) the information on the movable property and/or the movable property collateral received from the mobile reader 30 in the database 130.

Furthermore, the movable property electronic registration system 200 compares (S20) the information on the movable property and/or the movable property collateral stored in the database 130 database 130 with the information on the movable property and/or the movable property collateral stored in the movable property electronic registration server 210 so as to detect (S30) double registration of a single movable property 10.

In the movable property security system 300, the gate reader 50 automatically checks whether a movable property 10 is moved out of the location as recognized by the information on the movable property stored in the database 130, gives a warning signal (S40) when the movable property 10 is moved out of the location, checking whether a movable property 10 and/or parts thereof is moved out or lost on the spot, conducts the periodic comparison of the current status of the movable property 10 with history thereof, and finally displays the result of the periodic comparison (S50).

In addition, the movable property evaluation system 400 conducts the periodic comparison of the current status of the movable property 10 with the history, gives a rate or a score (S60) for the management status of the movable property 10, and uses the rate or the score for such evaluation (S70) of the movable property 10 as credit management and pricing.

The movable property disposal system 500, for the purpose of sale, exchange or disposition of the movable property 10, makes proper categorization and combination of the information on the movable property and/or the movable property collateral under a preset criteria based on the database 130, and discloses information (S80) necessary for the trading of the movable property 10, and further, for the effective management and disposition of the movable property 10, conducts various advisory services (S90) including repair of the movable property, exchange and replacement of parts thereof, search for potential foreign or local buyers, price negotiations, maintenance guarantee, and so on.

Although the present invention has been described herein in connection with certain disclosed embodiments, many modifications and variations to those embodiments may be implemented. For example, different types of end effectors may be employed. Also, where materials are disclosed for certain components, other materials may be used. The foregoing description and following claims are intended to cover all such modification and variations.

### DESCRIPTION OF DRAWINGS

FIG. 1 is a block diagram illustrating a movable asset management system using AIDC technologies according to an embodiment of the present invention;

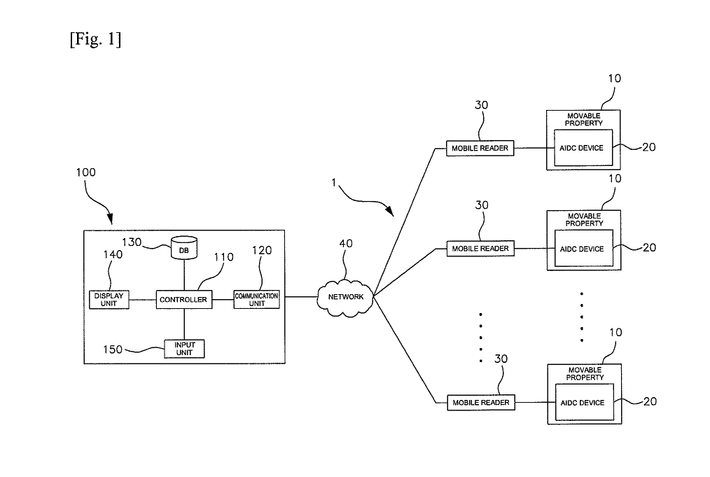

FIG. 2 is a block diagram illustrating the movable asset management system using AIDC technologies with a movable property electronic registration system of FIG. 1;

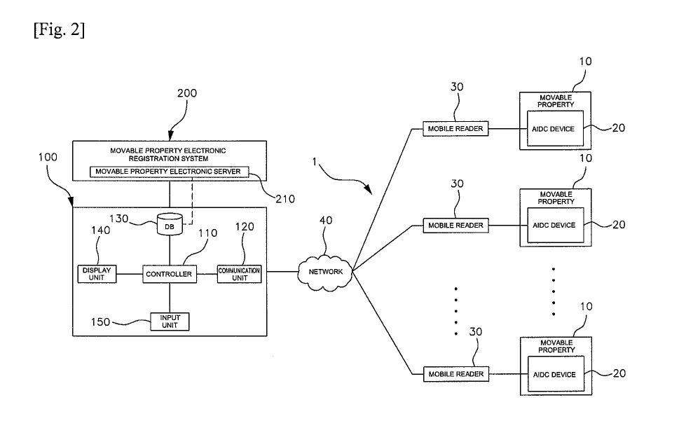

FIG. 3 is a block diagram illustrating the movable asset management system using AIDC technologies with a movable property security system included of FIG. 2;

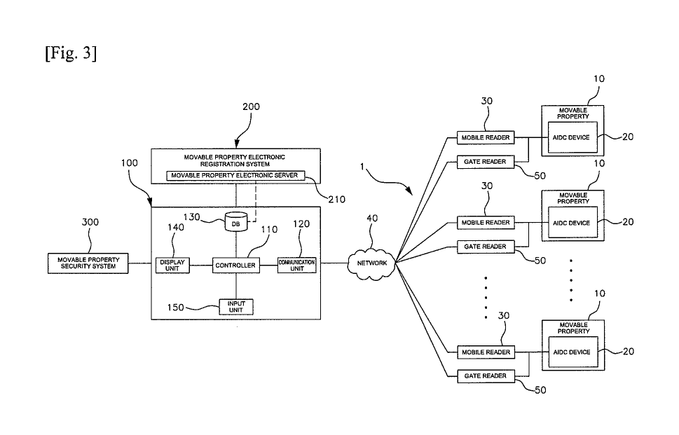

FIG. 4 is a block diagram illustrating the movable asset management system using AIDC technologies with a movable property evaluation system and a movable property disposal system of FIG. 3; and

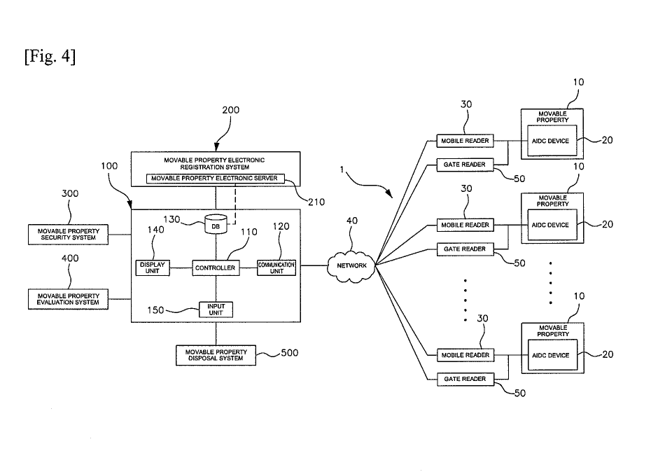

FIG. 5 is a flowchart illustrating a method of operating the movable asset management system using AIDC technologies according to an embodiment of the present invention.

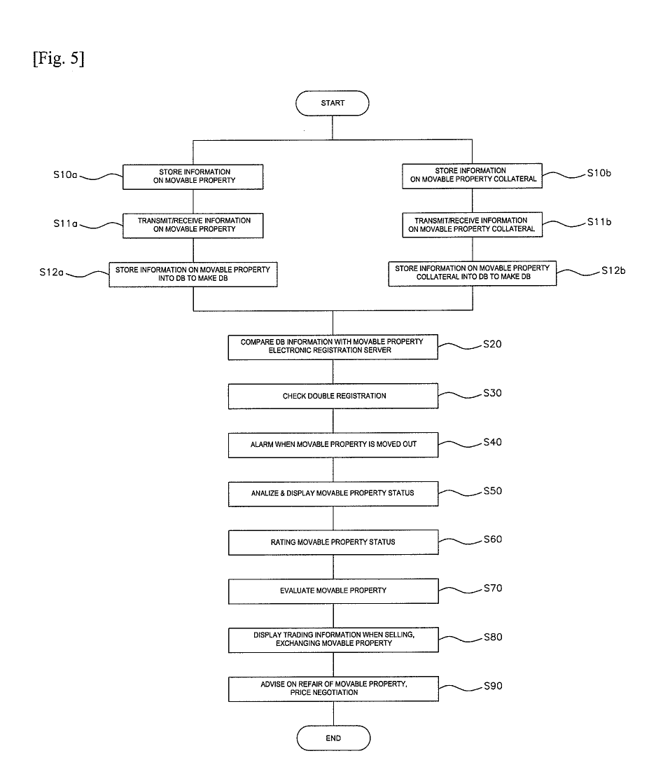

[Description of Reference Numerals
for Main Components of the Drawings]

| | |
|---|---|
| 1: movable asset management system | 10: movable property |
| 20: AIDC devices | 30: mobile reader |
| 40: network | 50: gate reader |
| 100: database system | 110: controller |
| 120: communication unit | 130: database |
| 140: display unit | 150: input unit |

200: movable property electronic registration system
210: movable property electronic registration server
300: movable property security system
400: movable property evaluation system
500: movable property disposal system

1. A movable asset management system using AIDC technologies comprising:
an AIDC device for storing information relating to movable property and/or information relating to movable property collateral, and for transmitting the information relating to movable property and/or information relating to movable property collateral to an external device;
wherein the information relating to movable property is posted on the movable property,
wherein the information relating to movable property includes information for specifying the movable property, information of location of the movable property, information for identifying a owner of the movable property, and information of current status about usage of the movable property,
and wherein the information relating to movable property collateral includes information for identifying an obligor and a secured creditor when security interest is created thereon, information on the secured credit amount and maximum amount of the security interest, and information on cause of registration, registration date, existence period and a serial number of registration when the security interest has been registered,
a mobile reader for receiving the information relating to the movable property and/or the information relating to the movable property collateral, transmitted from the AIDC devices, and for transmitting the information relating to the movable property and/or the information relating to the movable property collateral to a database system via networks;
a communication unit for receiving the information relating to the movable property and/or the information relating to the movable property collateral from the mobile reader;
a database for storing the information relating to the movable property and/or the information relating to the movable property collateral;
a control unit for controlling and managing the database;
a display unit, connected to the control unit, which displays the information relating to the movable property and/or the information relating to the movable property collateral, received by the communication unit; and
an input unit, connected to the control unit to be operated by a user to retrieve and search the information relating to the movable property and/or the information relating to the movable property collateral, stored in the database.

2. The movable asset management system as claimed in claim 1, further comprising a movable property electronic registration system which receives the information relating to the movable property and/or the information relating to the movable property collateral from the database,
and compares the information relating to the movable property and/or the movable property collateral which is stored in the database with original information relating to the movable property and/or the movable property collateral so as to search for double registration of a single movable property.

3. The movable asset management system as claimed in claim 1, further comprising a gate reader checking whether the movable property is moved out of a location of the movable property recognized from the information about the movable property stored in the database; and
a movable property security system alarming when it is determined that the movable property is moved out of the location by the gate reader, and displaying of results of periodic comparison and analysis of the status quo movable property with traceable history thereof.

4. The movable asset management system as claimed in claim 1, further comprising a movable property evaluation system generating a score or rate subject to the periodic comparison and analysis of the status quo movable property with the traceable history, and assessing value of the movable property based on the score or rate.

5. The movable asset management system as claimed in claim 1, further comprising a movable property disposal system classifying the information relating to the movable property and/or the information relating to the movable property collateral into several categories and combinations thereof under predetermined criteria based on the database, and discloses information necessary for the trading of the movable property.
